(19) United States
(12) Patent Application Publication
(10) Pub. No.: US 2006/0026379 A1
(43) Pub. Date: Feb. 2, 2006

(54) Effective memory management method and device in object-oriented application

(75) Inventor: Un-gyo Jung, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/189,743

(22) Filed: Jul. 27, 2005

(30) Foreign Application Priority Data
Jul. 27, 2004 (KR) 10-2004-0058710
Sep. 6, 2004 (KR) 10-2004-0070939

(51) Int. Cl. G06F 12/00

(52) U.S. Cl. 711/170

(57) ABSTRACT

An effective memory management method and device in an object-oriented application are provided. The memory management method in an object-oriented application includes: receiving a signal requesting allocation of a memory area to an object; receiving information on the object-oriented application including the object from an application manager; allocating a memory area to the object; and storing the information on the application and position information of the memory area allocated to the object.

### CROSS-REFERENCE TO RELATED APPLICATIONS

This application claims priority from Korean Patent Application Nos. 10-2004-0058710 and 10-2004-0070939 filed on Jul. 27, 2004 and Sep. 6, 2004, respectively, in the Korean Intellectual Property Office, the disclosures of which are incorporated herein by reference in their entireties.

### BACKGROUND OF THE INVENTION

1. Field of the Invention

Apparatuses and methods consistent with the present invention relate to effective memory management in object-oriented applications.

2. Description of the Related Art

Object-oriented programming is a method of developing a computer program, which is based on objects and resources rather than operations and logic. Conventional programs are recognized mainly as the logical operations that involve inputting, processing, and outputting data. The programs focus on what logic to use, instead of how to define data.

On the other hand, the object-oriented programming emphasizes objects rather than logic in programming. Examples of the objects include persons expressed by names and addresses, buildings, and shops whose characteristics can be described and treated to buttons and scroll bars which are small relative to a computer screen.

The object-oriented programming begins with a process of identifying the relationship between the objects to be treated, which is frequently referred to as “data modeling”. If identified, all objects are generalized into object classes. Kinds of data which the object classes contain and all possible logical orders in which they are treated are defined.

The logical order is called a “method” and an actual instance of a class is called an “object” or an “instance of class” in a certain situation. The object or instance of class is actually executed by a computer. The “method” defines commands, and characteristics of object classes define relevant data.

Smalltalk is one of the first object-oriented programming languages. C++ and Java are recently the most popular object-oriented programming languages. Specifically, Java was designed to be used for distributed application programs in a company or over Internet. Since Java applications are executed by Java virtual machines, they enables programs to run independent of their system hardware. Accordingly, Java applications serve as the main applications in a variety of digital devices, or are embedded in the digital devices to perform their functions.

Developments of computing abilities and advancement in digital technologies have made it possible to apply to a variety of digital devices whose application was restricted to computer systems in the past. Specially, developments of multimedia and digital broadcast have encouraged a great deal of research on digital televisions and mobile phones. The digital televisions and the mobile phones have to perform a lot of functions, because they interactively communicate with a user while receiving multimedia contents. The digital televisions require the function that is interlocked with a user interface in order to make available the interactive television. Accordingly, applets, components, and distributed objects of Java, C++, Common Object Request Broker Architecture (CORBA), etc. are used in the digital devices.

On the other hand, a memory manager is required to execute an application program such as an object-oriented component and an applet. The repetition of frequent loading and destruction of the application programs in computers, mobile phones, and digital televisions requires changing memory areas not in use to memory areas available. Garbage collection does that job. However, the garbage collection is not effective for systems in which objects are frequently generated and destroyed, because it requires the whole memory to be searched and switched. The limitation to memory capacity in digital televisions or mobile phones requires more effective memory management in executing object-oriented programs than in a computer.

### SUMMARY OF THE INVENTION

The present invention provides effective memory management method and device in an object-oriented application which may provide enhanced efficiency.

The present invention may rapidly collect memory areas which relevant objects occupy when an application is destroyed, by allocating memory areas to objects in a unit of application in executing an object-oriented program.

According to an aspect of the present invention, there is provided a memory management method in an object-oriented application, the method comprising: receiving a signal requesting allocation of a memory area to an object; receiving information on an application including the object from an application manager; allocating a memory area to the object; and storing the information on the application and position information of the memory area allocated to the object.

According to another aspect of the present invention, there is provided a memory management method in an object-oriented application, the method comprising: when the object-oriented application is destroyed, receiving a signal indicating destruction of the object-oriented application; checking a memory area allocated to an object constituting the object-oriented application; and collecting the memory area as an available memory area.

According to another aspect of the present invention, there is provided a memory management device in an object-oriented application, the memory management device comprising: an object-information receiving unit receiving a signal requesting allocation of a memory area to an object and receiving information on the object-oriented application including the object from an application manager; an application-memory management unit storing and managing the received information; and a memory-allocation management unit allocating a memory area to the object, wherein the application-memory management unit stores the information on the object-oriented application and position information of the memory area allocated to the object.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a process flow of an xlet according to an exemplary embodiment of the present invention;

FIG. 2 is a block diagram illustrating conventional constructions of a memory manager and an application manager;

FIGS. 3A, 3B, and 3C are exemplary views illustrating a conventional process of destroying an xlet to which memory areas are allocated;

FIG. 4 is a block diagram illustrating interactions between a memory manager and an application manager according to an exemplary embodiment of the present invention;

FIG. 5 is a flowchart illustrating a process of allocating memory areas to objects according to an exemplary embodiment of the present invention;

FIG. 6 is a flowchart illustrating a process of collecting the memory areas when an application is destroyed according to an exemplary embodiment of the present invention;

FIG. 7 is an exemplary view illustrating the allocation of objects according to an exemplary embodiment of the present invention;

FIG. 8 is an exemplary view illustrating the removal of resources according to an exemplary embodiment of the present invention;

FIG. 9 is an exemplary view illustrating the collection of memory areas according to an exemplary embodiment of the present invention; and

FIG. 10 is a block diagram illustrating constructions of a memory manager and a memory according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the attached drawings.

Prior to the description, the meanings of the terminologies used in the present specification will be simply described.

ActiveX Control

An activeX control can be prepared in all the programming languages supporting Component Object Model (COM) of Microsoft Corporation. The activeX control is a component or an independent program, and can be created and reused by various programs in a computer or a distributed network. The support of distributed environment in COM is specifically referred to as Distributed Component Object Model (DCOM). The activeX control can be considered as a kind of DLL module from the view point of actual embodiment, and is executed in an application program including a COM program interface, which is referred to a “container”. The approach using reusable components contributes to reduction of development time for application programs and improvement in function and quality of the programs. Application development tools of Window 95/NT such as Power Builder and Microsoft Access utilize such advantages of the activeX control. Visual Basic and C++ are widely used for creating OCX or activeX control.

Java

Java is a programming language designed for use in distributed environments of Internet. Java is similar to C++, but is simpler in use than C++ and has reinforced object-orientation in programming. Java can be used to create an application which can be executed by a computer or a distributed client/server on a network. In addition, Java can be used to create small application program modules or applets which are used as a part of a web page. Applets allow users to interact with each other through web pages.

Java Application

A Java application is a program which is executed by Java virtual machines using Java objects. The Java application includes an applet, an xlet, and a midlet.

Applet

A Java applet is a Java program which is included in a Hypertext Markup Language (HTML) page and which can be executed by a Java-compatible web browser. When a Java-compatible web browser displays an HTML page containing a Java applet, a Java applet code of a web server is downloaded and is executed in a specific area of the web browser.

An applet is an embedded application which is executed by a web browser. Since the page in which the applet is executed provides an area in which the applet is displayed, the applet is closely associated with the web page containing the applet.

A life cycle of the applet includes a loaded status, a stopped status, a started status, and a destroyed status. The loaded status means that instances of the applet is created but not initialized yet. The stopped status means that the applet is initialized but not under execution. The started status means that the applet is activated. The destroyed status means that the applet is finished and the instances of the applet give back all the resources and wait for collection of memory areas through garbage collection.

Midlet

A midlet is a mobile information device profile (MIDP) application. Unlike the applet, the midlet is not managed by a web browser but is managed by software made specifically to control applications installed in an interactive pager or a mobile phone. When a call is received in the course of execution of the application, the application should not hinder the reception of the call. Therefore, in this case, such external management is suitable for the application which is executed by mobile devices.

A life cycle of the midlet includes a stopped status, an active status, and a destroyed status. The midlet does not include a status corresponding to the loaded status of an applet.

Xlet

An xlet was originally a part of Java television application programming interface (API), but is now used in a personal basis profile (PBP) and a personal profile (PP) which is a super set thereof. When the xlet is destroyed, the xlet gives back the resources and waits for the garbage collection.

Garbage Collection

Garbage is a part of memory areas which are allocated to a program or an application but not used anymore. For example, when a memory area is allocated to an object but the object is destroyed, the memory area is considered as in use by not setting the memory area as an available memory area. Therefore, the memory area which is not used and cannot be used is referred to as garbage, and a process of changing such garbage to available memory areas is required for a system. Such a process is referred to as a “garbage collection”.

The garbage collection includes marking that a memory area is garbage and changing the garbage to an available memory area.

The Java applications are applied to a variety of systems such as computer systems or home electronics of digital televisions, etc. The digital televisions have multimedia coupled with Internet, and are also referred to as interactive televisions, which interact with users. The Java applications are used in computers, digital televisions, mobile phones, etc. and include Java applets, xlets, midlets, etc.

Such Java applets, xlets, midlets, activeX controls, etc. are different depending upon the systems, and constitute object-oriented applications, thereby enhancing user convenience and interoperability in a variety of electronic products. In the following description, the xlets are mainly focused. However, it is only an exemplary embodiment of the present invention. The scope of the present invention includes the applets, midlets, activeX controls, etc. The object-oriented applications are provided which are executed independently or in an embedded state by a variety of electronic products or digital devices. Objects or components of CORBA and C++ controls or components are all included in examples of the object-oriented applications. However, in the following description, the xlets of the Java applications which can be variously applied to the digital televisions are mainly described.

Operations of applications such as xlets are described below.

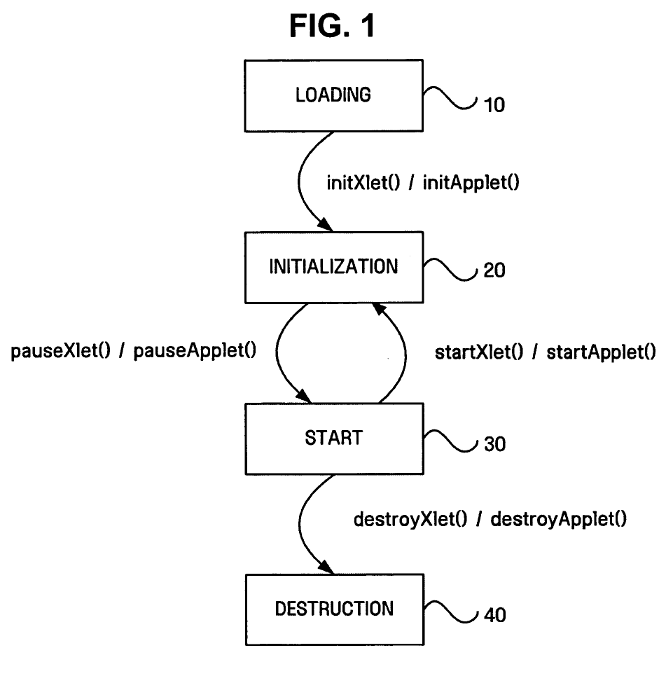

FIG. 1 is a block diagram illustrating a process flow of an xlet according to an exemplary embodiment of the present invention. First, an xlet is loaded in a memory (10). When the xlet is initialized with “initXlet( )”, it is prepared for execution (20). The loading of the xlet in the memory means that objects constituting the xlet occupy certain areas of the memory. The xlet manages its objects using a data structure such as a heap. The initialized xlet is not yet activated, so it should be started to execute (30). That is, the initialized xlet can work with “startXlet( )”. The xlet under work can be paused, which can be performed with “pausexlet( )”. The paused xlet temporarily stops its work but there is no change in occupation of memory. The start (30) and the initialization (20) can be performed several times. However, when the xlet is destroyed (40), it can not be used any more. In order to reuse the xlet, the loading (10) should be performed again.

Only when the destroyed xlet should restore the memory area which is occupied by the xlet, another xlet or system can use the relevant memory area. The memory area occupied by the xlet includes memory areas occupied by the objects constituting the xlet. Conventionally, garbage collection has been used for reusing the memory areas. The garbage collection is performed by searching the whole memory for use. The garbage collection can be performed in real time or in a certain time, depending upon systems. However, since the real-time garbage collection requires checking the whole memory, the garbage collection is performed with a predetermined gap of time.

When xlets, applets, or C++ component are under work in a digital televisions, a mobile phone, or a computer for the purpose of providing multimedia information or for the purpose of a user's convenience, the loading and the destruction can frequently occur. However, when the objects constituting the destroyed application such as an xlet and an applet occupy the memory for a constant time, the memory efficiency can be deteriorated. The garbage collection can be performed so as to prevent the deterioration in memory efficiency. However, in this case, the whole memory is searched for the garbage collection every time each xlet or applet is destroyed, which is not effective in view of performance and time of a system.

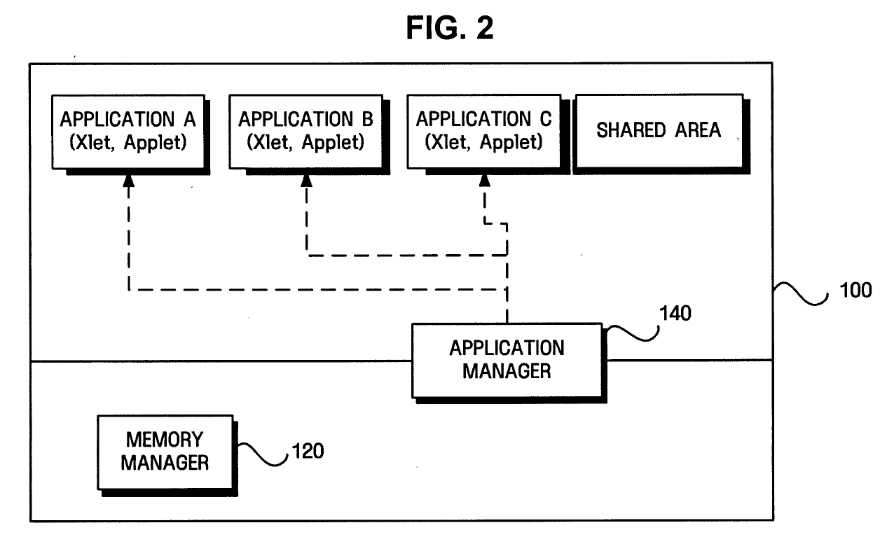

FIG. 2 is a block diagram illustrating conventional constructions of a memory manager and an application manager. The application manager 140 manages creation, initialization, and destruction of an application. Here, an application is an object-oriented application as described above, and may include an xlet, an applet, a midlet, and a C++ component.

The memory manager 120 allocates a memory area to an object when the object is created. That is, the memory manager 120 arranges memory areas allocated to objects belonging to the destroyed application such as an xlet and an applet and then sets the memory areas as available memory areas. However, the garbage collection is not performed dynamically in conjunction with the destruction of an xlet or an applet, but is independently performed by the memory manager 120 with a predetermined time gap after the xlet, etc. is destroyed. Accordingly, the memory areas can be reused. As described above, the garbage collection in real time causes problems in view of time and performance.

Therefore, in order to reuse memory areas after an xlet, etc. is destroyed, there is a difficulty that the whole memory should be searched. When the garbage collection is performed with a predetermined gap of time in order to avoid frequent search, there exist memory areas which is not used and can be used by another object. Accordingly, the memory areas not used, that is, the garbage, have a negative effect on the system performance. Specifically, in a digital device having frequent execution and destruction of an application, the garbage memory areas can deteriorate the whole system performance.

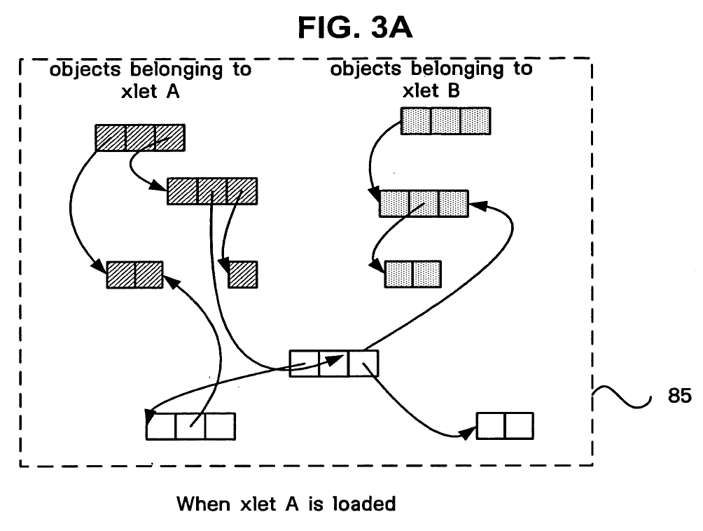

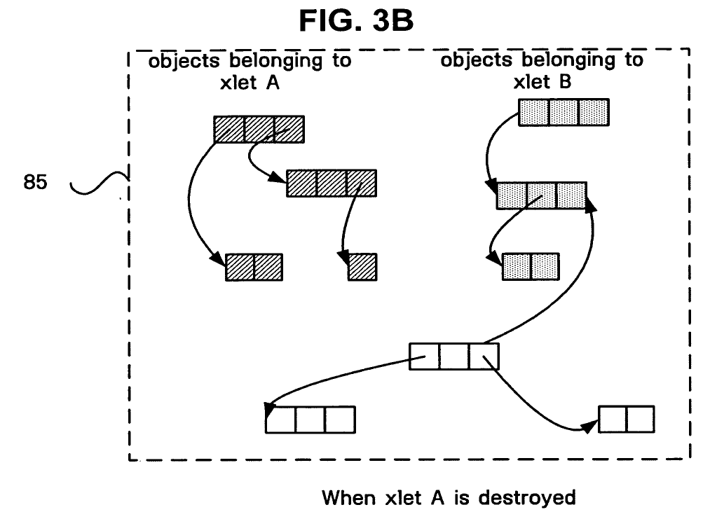

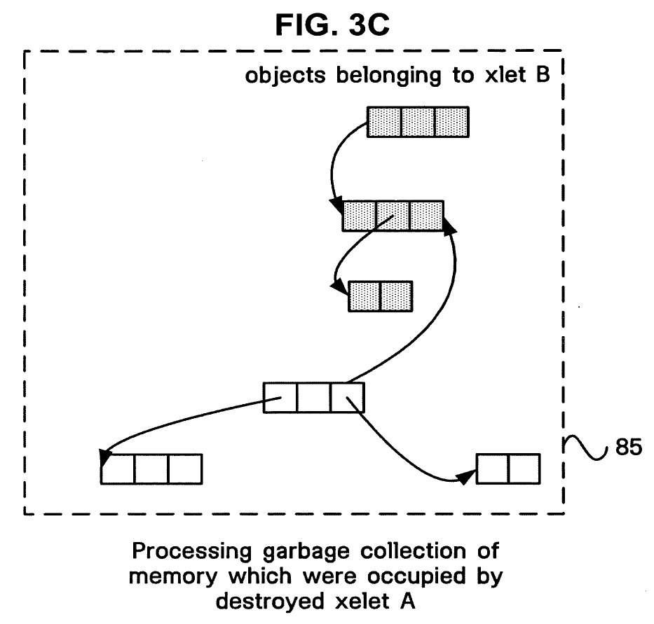

FIGS. 3A, 3B, and 3C are exemplary views illustrating a conventional process of destroying an xlet to which memory areas are allocated.

FIG. 3A shows loading an xlet A. In the loading operation, the objects belonging to the xlet A form a heap. When the xlet A is loaded in a memory and accesses resources for common memory areas, the common memory areas can form a heap. The xlet A can be activated or stopped while occupying a part of the memory areas. An xlet B is similar to the xlet A. Here, the xlet A and the xlet B use the same heap area, and the memory areas which are occupied by the xlet A and the xlets B are not distinguished.

FIG. 3B shows the destruction of the xlet A. The xlet is destroyed and cannot be used anymore. However, the memory areas occupied by the objects belonging to the xlet A remain as they are. Therefore, the memory areas cannot be used by other objects or xlets or systems. Of course, when the garbage collection is performed as shown in FIG. 3C, the memory areas (85) can be used by other systems or xlets. However, in order to perform the garbage collection as in FIG. 3C, the whole memory heaps should be searched, it should be checked what memory areas are used, and the change to available memory areas should be performed. Accordingly, there is a disadvantage that memory areas in use should be searched.

When the time gap between the operations of FIGS. 3B and 3C is increased, the quantity of available memory areas is decreased. Therefore, there are required a method and a device for reusing memory areas while reducing the search times for the whole memory, by allocating memory areas in a unit such as an xlet which is loaded in a memory and destroying the unit.

FIGS. 3A, 3B, and 3C show objects constituting specific xlets in a memory space, where the objects are visually arranged. However, the objects are not physically distinguished, but the objects can be visually connected to each other even when the objects are physically distributed.

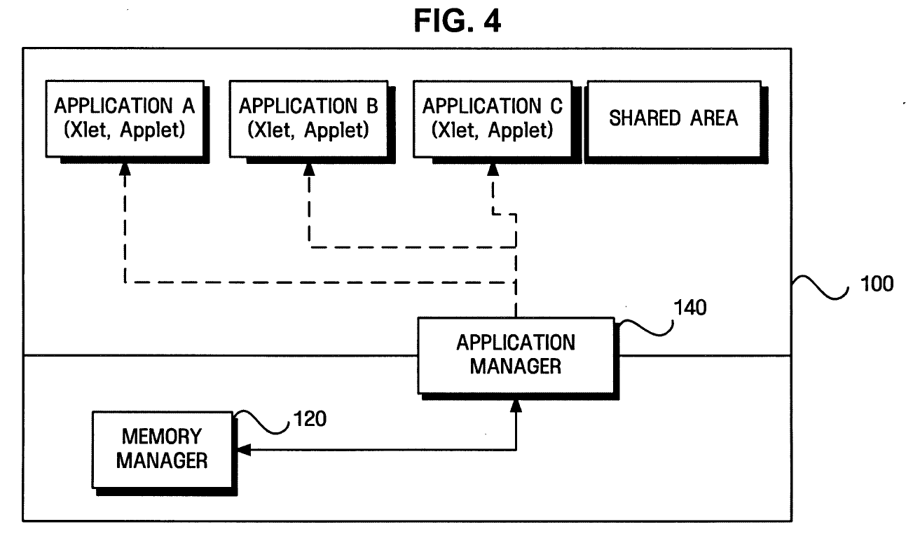

FIG. 4 is a block diagram illustrating interactions between the memory manager 120 and the application manager 140 according to an exemplary embodiment of the present invention.

The application manager 140 manages creation and destruction of an application such as an xlet and an applet. The memory manager 120 allocates memory areas to objects. The memory manager 120 inquires of the application manager 140 what xlet or applet includes a relevant object before allocating a memory area to the object. When the memory manager 120 is informed from the application manager 140 what xlet or applet include the relevant object, the memory manager 120 allocates a memory area of the object to the memory space (for example, memory heap) allocated to the application (for example, xlet). When an xlet or a component is destroyed, the memory areas occupied by the objects constituting the application can be collected and reused, by creating and managing a sub heap in a unit of xlets or in a unit of applications such as components or applets. The use of a sub heap is only an example and the memory space may be constructed to chase the objects belonging to a specific application. A specific memory space may be physically divided and may be logically divided such that physically-distributed objects are positioned in a logical area. Such a logical area may include a link list, various trees such as binary trees or B-trees, etc., in addition to the sub heap described above. Of course, the memory space may be constructed using a hash table, and may be constructed using a small table which stores position information of the objects. The construction of the memory space can be different depending upon characteristics of the relevant system or application, and thus a construction suitable for the relevant system can be selected to manage the memory. The application manager 140 may serve as an xlet manager, an applet manager, or a component manager.

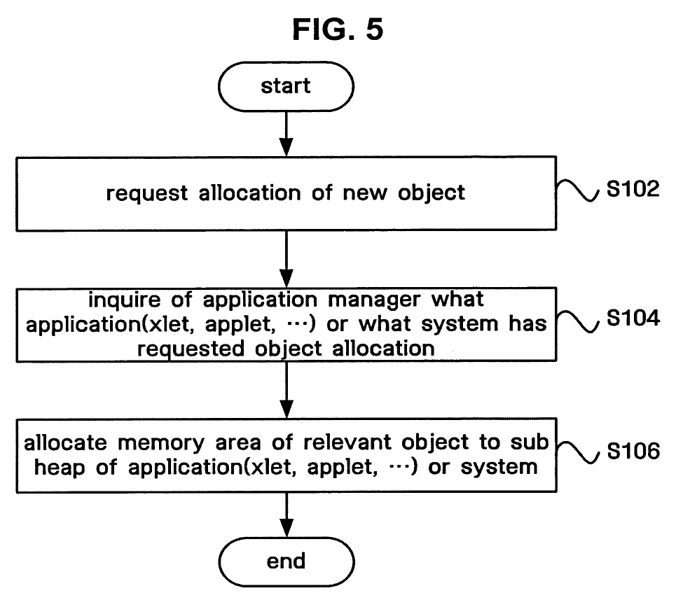

FIG. 5 is a flowchart illustrating a process of allocating memory areas to objects according to an exemplary embodiment of the present invention.

The memory manager 120 receives a request to allocate a memory area to an object (S102). The memory manager 120 receiving the request inquires of the application manager 140 what application (xlet, applet, component, etc.) the object belongs to (S104). Then, the application manager 140 sends to the memory manager 120 information on the application (xlet, applet, component, etc.). The memory manager 120 receiving the information on the application including the object allocates the memory area of the object to a sub heap allocated to objects constituting the application (S106). In this way, the objects belonging to the application are stored in the same sub heap.

The memory area of the object may be allocated to a specific memory space, that is, the sub heap in the above-mentioned example, by allocating a memory area to the object and linking position information of the memory area with the sub heap. In this example, the memory areas physically separated are logically connected to each other. A memory space physically distinguished may be allocated to a specific application. This means that the objects physically constituting an application are collected and stored. In the present invention, the allocation of memory areas means all the physical and logical connections.

In FIG. 5, a sub heap is constructed in a unit of applications such as xlets or applets. Accordingly, when an application such as an xlet or an applet is destroyed, it is possible to easily track and reuse the relevant objects. The use of sub heaps is only an example, and various data structures such as a link list or a tree may be used instead of the sub heap.

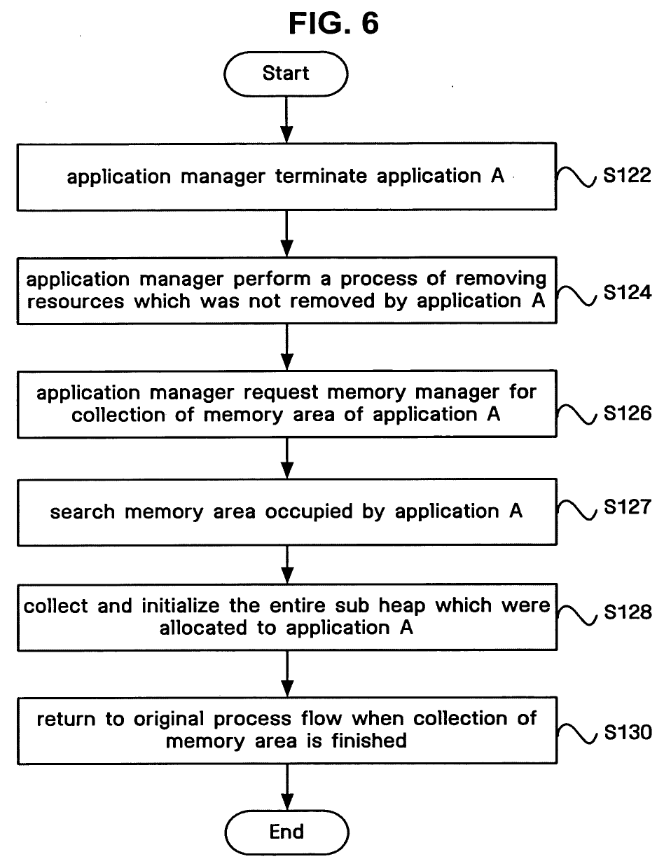

FIG. 6 is a flowchart illustrating a process of collecting the memory areas when an application is destroyed according to an exemplary embodiment of the present invention.

The application manager 140 terminates an application A (S122). This situation can occur when an xlet or an applet is destroyed. Then, the application manager performs a process of removing resources not removed by the application A (S 124), and requests the memory manager to collect the memory areas occupied by the application A (S126). The memory manager searches the sub heap which is a memory area allocated to the application A and thus acquires information on the memory area occupied by the application A (S127). The memory manager collects the entire memory area of the application A which is constructed in a sub heap through the above-mentioned search and initializes the entire memory area (S128). When the process of destroying the application A is completed through the collection of memory area, the original process flow is performed (S130).

The application in FIG. 6 is an object-oriented application such as an xlet, an applet, a midlet, a C++ component, etc., and the sub heap is an example for easily tracking the objects allocated to each application.

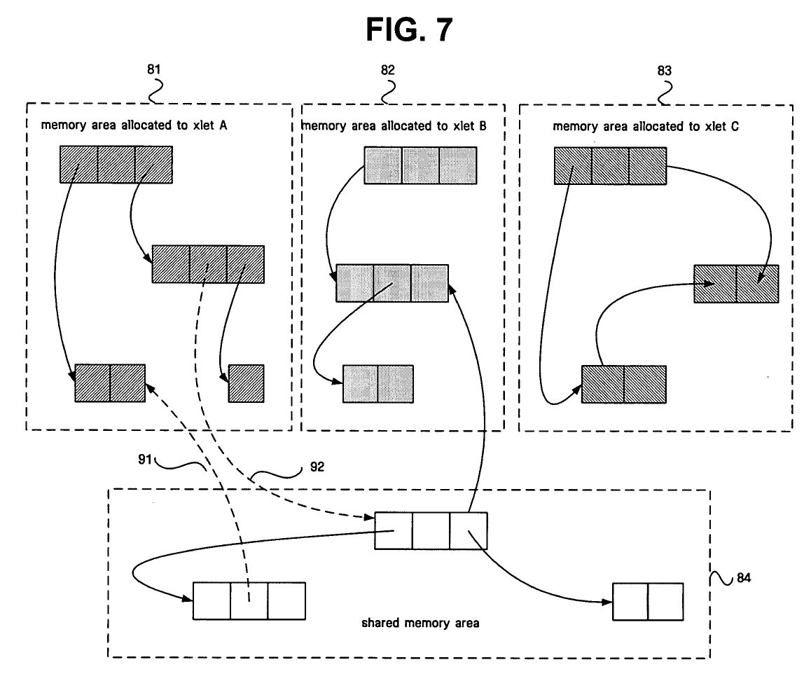

FIGS. 7 to 9 are block diagrams illustrating processes in which objects constituting a *specific application or shared by systems form a sub heap, a memory area is allocated to the objects, and the memory area is collected again when the application is destroyed. In FIGS. 7 to 9, xlets are used as an example of the application, the objects constituting the application form a sub heap, and the objects can be tracked in a unit of application. The memory can be constructed using a link list and the memory area can be allocated to the objects in a unit of application using a tree structure.

FIG. 7 is an exemplary view illustrating the allocation of objects according to an exemplary embodiment of the present invention. The memory areas are allocated to the objects through the process shown in FIG. 5. Reference numerals 81, 82, and 83 denote memory areas of xlets A, B, and C, respectively. A reference numeral 84 denotes a common memory space that objects of system can occupy. Since the memory manager allocates the objects belonging to the respective xlets to the relevant sub heaps, the memory partition of the xlets are performed logically or physically. Reference numerals 91 and 92 denote that the xlet A uses an external resource or a shared resource.

A memory space is divided visually in FIG. 7, but the memory space is not actually partitioned only in a unit of application such as xlet or applet. That is, the memory space may be constructed to be logically distinguished and may be physically partitioned to store the objects in a unit of application. In an actual memory, the objects may be distributed independently of the xlets. However, the objects can be associated with a particular link or heap so as to track the objects in a unit of xlet. The link or heap in a data structure is not regulated by physical addresses of memory areas but is logically connected to form a structure.

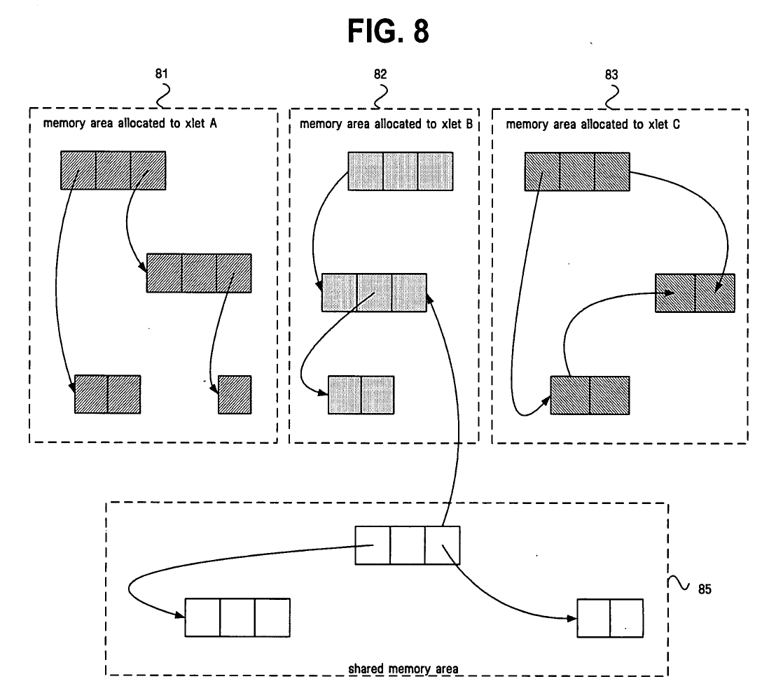

FIG. 8 is an exemplary view illustrating the removal of resources according to an exemplary embodiment of the present invention. FIG. 8 corresponds to S122 and S124 of FIG. 6. When the xlet A uses the objects in the system area, external resources are not used, which is performed by removing 91 and 92 of FIG. 7. However, the memory area of the xlet A remains in a sub heap type.

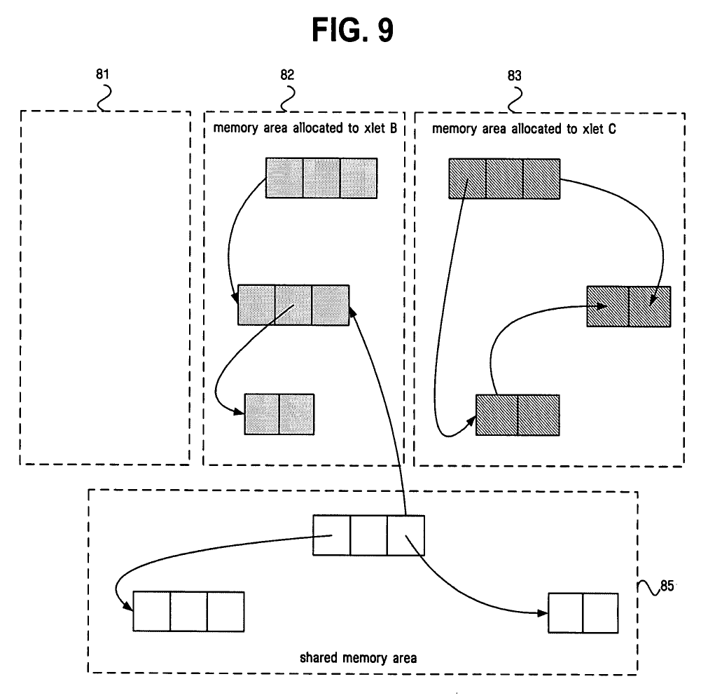

FIG. 9 is an exemplary view illustrating the collection of a memory area according to an exemplary embodiment of the present invention. As described with reference to FIGS. 7 and 8, sub heaps are constructed in a unit of xlet or applet. The memory manager has the information on the sub heap. Therefore, the memory area of the objects in the xlet A can be identified by tracking the sub heap, and the garbage memory area can be removed by changing the memory area constituting the sub heap to an available memory area.

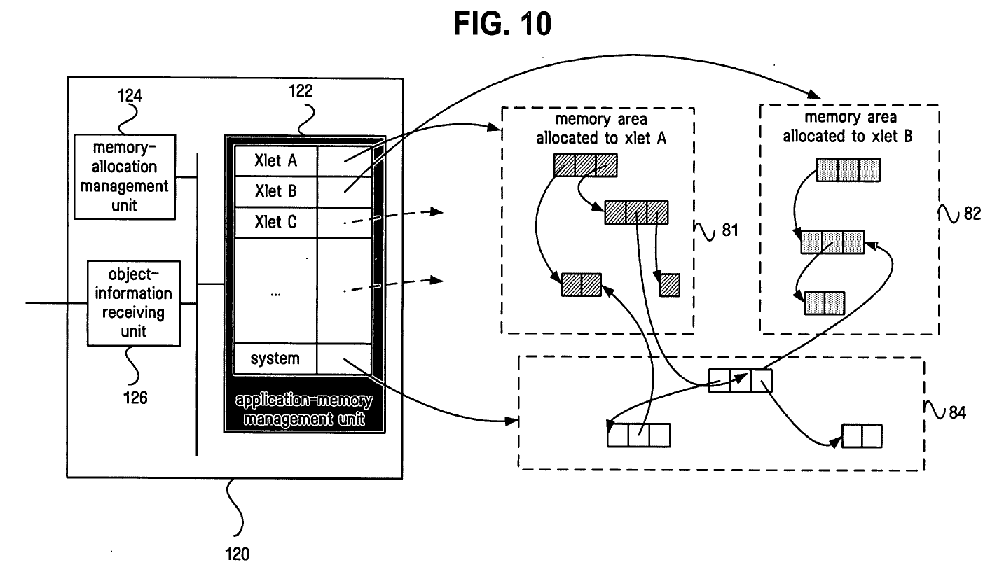

FIG. 10 is a block diagram illustrating constructions of the memory manager and the memory area according to an exemplary embodiment of the present invention.

The memory manager 120 approximately comprises an application-memory management unit 122, a memory-allocation management unit 124, and an object-information receiving unit 126.

The application-memory management unit 122 includes pointers for applications and sub heaps occupied by the objects belonging to the applications. A pointer means position information of a memory area. When a memory area is allocated to an object belonging a specific application using such position information, the application-memory management unit stores information which indicates a position of a memory area at which the object is stored. As described above, such information can be obtained by constituting a sub heap or using a link. Necessary memory areas can be allocated to objects at the same time as performing such a process or before or after performing such a process. When the application is destroyed, the memory areas allocated to the objects of the application can be changed to available memory areas in accordance with the information from the application-memory management unit 122, thereby performing the garbage collection. The application-memory management unit 122 has a function of managing the memory areas of the objects belonging to an application such as an xlet and an applet and the objects shared with several applications in the same system in a unit of applications or in a unit of systems.

The memory-allocation management unit 124 allocates a memory area and collects garbage. When the memory-allocation management unit 124 is requested to allocate a memory area to an object via the object-information receiving unit 126, the memory-allocation management unit 124 checks the application (xlet, applet, etc.) including the object, determines a sub heap occupied by relevant objects stored in the application-memory management unit 122, and allocates a memory area to the object. When a Java virtual machine instructs the garbage collection, the memory area which is not used but occupied is changed to an available memory area. Since the memory areas of the sub heap corresponding to the destroyed xlet is garbage, the memory-allocation management unit 124 collects the memory area and changes it to an available memory area.

The object-information receiving unit 126 interacts with the application manager taking charge of the creation and destruction of an application, such as an xlet manager or an applet manager. When the object-information receiving unit 126 is requested to allocate a memory area in response to the creation of an object constituting an application, the object-management reception unit 126 inquires what xlet or applet the object belongs to. It is the object-information receiving unit that performs the transmission and reception of information.

The memory manager, that is, a memory management device, is included in all the digital devices in which object-oriented applications of Java, CORBA, C++, etc. operate. Specifically, with the recent increase in necessity for an object-oriented application such as an xlet in a digital television, the memory manager can effectively manage resources of a digital device.

According to the present invention, it is possible to enhance the memory management efficiency in executing an object-oriented application.

According to the present invention, it is also possible to enhance the memory reuse rate in a unit of application in allocating a memory area to an object.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A memory management method in an object-oriented application, the method comprising:
receiving a signal requesting allocation of a memory area to an object;
receiving information on an application including the object from an application manager;
allocating a memory area to the object; and
storing the information on the application and position information of the memory area allocated to the object.

2. The memory management method according to claim 1, wherein the information on the application includes an identifier of the application.

3. The memory management method according to claim 1, wherein the application is one of an xlet, an applet, a midlet, an activeX control, a Common Object Request Broker Architecture (CORBA) component, and a C++component.

4. The memory management method according to claim 1, wherein the allocating the memory area to the object includes linking the memory area allocated to the object with a memory area allocated to another object constituting the application.

5. A memory management method when an object-oriented application is destroyed, the method comprising:
receiving a signal indicating destruction of the object-oriented application;
checking a memory area allocated to an object constituting the object-oriented application; and
collecting the memory area as an available memory area.

6. The memory management method according to claim 5, wherein the checking the memory area includes retrieving information on memory areas which can be identified by an identifier of the object-oriented application.

7. The memory management method according to claim 5, wherein the object-oriented application is one of an xlet, an applet, a midlet, an activeX control, a Common Object Request Broker Architecture (CORBA) component, and a C++ component.

8. The memory management method according to claim 5, wherein the collecting the memory area includes adding the memory area allocated to the object constituting the object-oriented application to the available memory area.

9. A memory management device in an object-oriented application, the memory management device comprising:
an object-information receiving unit which receives a signal requesting allocation of a memory area to an object, and information on the object-oriented application including the object from an application manager;
an application-memory management unit which stores and manages the received information; and
a memory-allocation management unit which allocates a memory area to the object,
wherein the application-memory management unit stores the information on the object-oriented application and position information of the memory area allocated to the object.

10. The memory management device according to claim 9, wherein the information on the object-oriented application includes an identifier of the object-oriented application.

11. The memory management device according to claim 9, wherein the object-oriented application is one of an xlet, an applet, a midlet, an activeX control, a Common Object Request Broker Architecture (CORBA) component, and a C++ component.

12. The memory management device according to claim 9, wherein the memory-allocation management unit links the memory area allocated to the object with a memory area allocated to another object constituting the object-oriented application.

13. The memory management device according to claim 9, wherein when the object-oriented application is destroyed,
the object-information receiving unit receives a signal indicating destruction of the object-oriented application, and
the memory-allocation management unit checks the memory area allocated to the object constituting the object-oriented application in the application-memory management unit and collects the memory area as an available memory area.

14. The memory management device according to claim 13, wherein the memory-allocation management unit checks the memory area by retrieving information on memory areas which can be identified by an identifier of the object-oriented application.

15. The memory management device according to claim 13, wherein the memory-allocation management unit collects the memory area by adding the memory area allocated to the object constituting the object-oriented application to an available memory area.

16. A recording medium for recording a computer-readable program making a computer execute a memory management method in an object-oriented application, the method comprising:
receiving a signal requesting allocation of a memory area to an object;
receiving information on an application including the object from an application manager;
allocating a memory area to the object; and
storing the information on the application and position information of the memory area allocated to the object.

17. A system for driving an object-oriented application comprising memory management device, the memory management device comprising:
an object-information receiving unit which receives a signal requesting allocation of a memory area to an object, and information on the object-oriented application including the object from an application manager;
an application-memory management unit which stores and manages the received information; and
a memory-allocation management unit which allocates a memory area to the object,
wherein the application-memory management unit stores the information on the object-oriented application and position information of the memory area allocated to the object.
